(19) United States
(12) Patent Application Publication
(10) Pub. No.: US 2008/0257432 A1
(43) Pub. Date: Oct. 23, 2008

(54) Valve including a rotary spool and check valves

(75) Inventors: Hanjo Nissen, Buhl (DE); Martin Staudinger, Ettlingen (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/012,703

(22) Filed: Feb. 5, 2008

(30) Foreign Application Priority Data
Feb. 6, 2007 (DE) 10 2007 005 774.3

(51) Int. Cl. F16K 11/078

(52) U.S. Cl. 137/625.17

(57) ABSTRACT

A valve having a housing and including a rotatable rotary spool that includes a conducting chamber. A first inlet communicates with the conducting chamber and with a plurality of outlets that are selectively individually connected with the conducting chamber as a function of the rotational position of the rotary spool within the valve housing. The conducting chamber communicates with a first pressure chamber through a first check valve carried by the rotary spool. A second check valve carried by the rotary spool provides communication between the first pressure chamber and a second pressure chamber that surrounds the rotary spool.

### BACKGROUND OF THE INVENTION

1. Field of the Invention

The present invention relates to a valve having a rotary spool with a conducting chamber, a first inlet to the conducting chamber, and a plurality of outlets that are individually connectable to the conducting chamber as a function of the rotational position of the rotary spool.

2. Description of the Related Art

Valves having a rotary spool are known. They can be used to actuate a hydraulically operated transmission of a motor vehicle, for example. In hydraulically shifted transmissions, normally one of several hydraulic cylinders must be subjected to a hydraulic pressure while the other cylinders remain unpressurized. As a rule, the hydraulic cylinders are combined by pairs into double cylinders, so that the pistons can be moved into a middle position or to one of two end positions by pressurizing the cylinders alternately.

An object of the present invention is to provide an improved valve, in particular a rotary spool valve having reduced leakage.

### SUMMARY OF THE INVENTION

The above-mentioned object is achieved with a valve that includes a rotatable spool and a conducting chamber to which a first inlet is connected, and to which a plurality of outlets are individually connectable. The outlets are connected based upon the rotational position of the rotary spool. The conducting chamber communicates with a first pressure chamber through a first check valve. Advantageously, a positive pressure existing in the conducting chamber can also be fed to the first pressure chamber. Also advantageously, pressure forces that develop in the pressure chamber when the conducting chamber is full of fluid can be utilized to supply a sealing force for the rotary spool.

In addition, the object is achieved with a valve having a rotatable spool with a conducting chamber and a first inlet connected to the conducting chamber, and wherein a plurality of outlets are individually connectable to the conducting chamber as a function of the rotational position of the rotary spool. The valve includes a cylinder connected with the rotary spool, wherein the cylinder is received in a bore in the valve housing with a clearance fit. Because of the clearance fit, the cylinder can advantageously assume a slight angular displacement relative to the axis of the bore. That condition can be used advantageously to compensate for possibly existing tolerances. In addition, the rotary spool with the cylinder can likewise assume a slight angle and in so doing better match a sealing surface, whereby leakage that can possibly arise between the rotary spool and the sealing surface can be prevented or at least reduced to a minimum.

Preferred exemplary embodiments of the valve are characterized in that an upper end face of the cylinder forms a first pressure surface, wherein the first pressure surface and the bore define the first pressure chamber. The pressure forces acting on the first pressure surface can be transmitted to the rotary spool via the end face of the cylinder, so that a sealing contact results between the rotary spool and the sealing surface.

Additional preferred exemplary embodiments are characterized in that a second pressure chamber surrounding the rotary spool is connectable to the first pressure chamber and the first pressure surface through a second check valve. When the second pressure chamber is pressurized, the first pressure chamber can also be pressurized through the second check valve. Advantageously, that pressurization also results in a higher contact force of the rotary spool with the sealing surface, and thus a tighter seal.

Additional preferred exemplary embodiments are characterized in that the valve has a second inlet associated with the second pressure chamber. The second pressure chamber can be pressurized via the second inlet.

Additional preferred exemplary embodiments are characterized in that when the first inlet is pressurized and the second inlet is unpressurized, the first check valve is open and the second check valve is closed, and vice versa. The check valves advantageously constitute an OR function, where one of the check valves is always open, so that the first pressure chamber is always pressurizable with the greatest pressure present at the inlets.

Additional preferred exemplary embodiments are characterized in that the cylinder has a peripheral groove to receive a sliding-seal ring that is associated with the bore and the cylinder to seal them. By way of the sliding-seal ring, which is received in the groove, the cylinder can be supported in the bore with a fluid-tight seal despite the clearance fit, and the pressure chambers can be separated from each other with a fluid-tight seal.

Additional preferred exemplary embodiments are characterized in that the rotary spool has a sealing surface situated opposite the first pressure surface, wherein pressure forces acting on the first pressure surface bring about a contact force for the sealing surface on an intermediate plate of a housing of the valve. In particular, through the pressure forces operating in the first pressure chamber, a sealing contact can be effected between the sealing surface of the rotary spool and the intermediate plate of the housing.

Additional preferred exemplary embodiments are characterized in that the intermediate plate bounds the conducting chamber of the rotary spool and includes the first inlet as well as the plurality of outlets. Advantageously, the rotary spool can associate one outlet of the plurality of outlets to the inlet by way of the conducting chamber. To that end, the intermediate plate that bounds the conducting chamber can be in sealing contact with the sealing surface of the rotary spool, and can have corresponding bores to achieve the plurality of outlets. The sealing surface can separate the conducting chamber and the second pressure chamber from each other with a fluid-tight seal.

Additional preferred exemplary embodiments are characterized in that the intermediate plate includes a second inlet. The second inlet can be in the form of a corresponding bore, for example outside of a perimeter of the conducting chamber. That enables the second inlet to be associated with the second pressure chamber.

Additional preferred exemplary embodiments are characterized in that the intermediate plate bounds the second pressure chamber. Advantageously, the intermediate plate can close the bore forming the second inlet, so that the closed bore results in the second pressure chamber. Situated inside the bore, or inside the second pressure chamber, is the rotary spool, and in it the conducting chamber.

### BRIEF DESCRIPTION OF THE DRAWINGS

The structure, operation, and advantages of the present invention will become further apparent upon consideration of the following description, taken in conjunction with the accompanying drawings in which:

FIG. 1 is a longitudinal cross-sectional view through a known rotary valve when it is in a first pressure condition;

FIG. 2 is a longitudinal cross-sectional view through the valve shown in FIG. 1 when it is in a second pressure condition;

FIG. 3 is a perspective view of a rotary spool in accordance with an embodiment of the present invention;

FIG. 4 is a perspective view, partially in section, of the rotary spool shown in FIG. 3 when it is in a first pressure condition; and

FIG. 5 is a perspective view, partially in section, of the rotary spool shown in FIG. 3 when it is in a second pressure condition.

### DESCRIPTION OF THE PREFERRED EMBODIMENTS

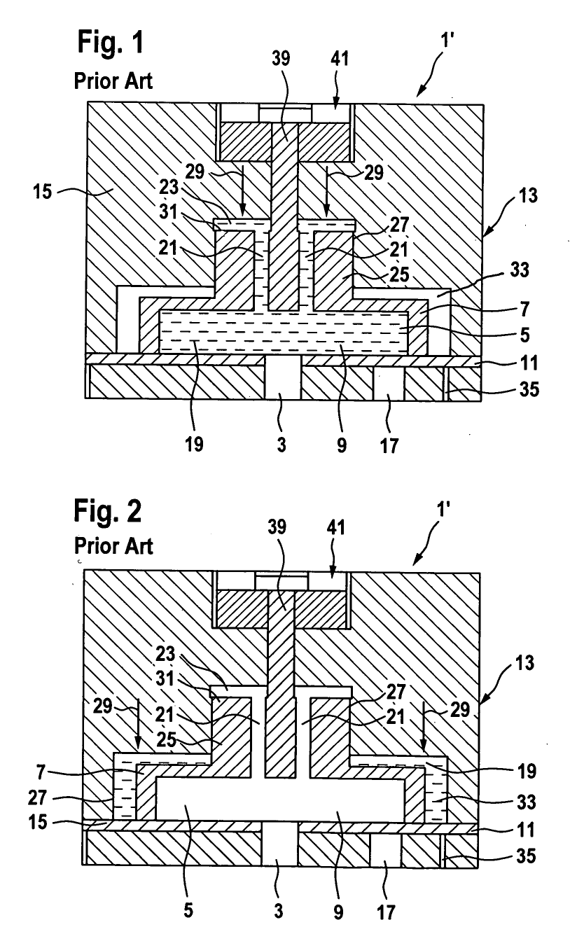

FIG. 1 shows a known rotary valve 1′ in a longitudinal cross-sectional view and when it is in a first pressure condition. FIG. 2 shows the valve 1′ of FIG. 1 when it is in a second pressure condition. Valve 1′ includes a first inlet 3, which leads into a conducting chamber 5 of valve 1′. Conducting chamber 5 is formed by a rotary spool 7 of valve 1′. More precisely, rotary spool 7 includes an essentially rectangular-shaped recess 9 that forms the conducting chamber 5.

Viewed in the orientation of FIGS. 1 and 2, conducting chamber 5 is bounded on the underside by an intermediate plate 11, which is part of a housing 13 of valve 1′. Housing 13 includes a base plate 15 that is joined to intermediate plate 11. Intermediate plate 11 includes a first inlet 3, in the form of a bore, for example. In addition, intermediate plate 11 includes a plurality of outlets, of which a first outlet 17 is visible in the views shown in FIGS. 1 and 2. At times one of the outlets, outlet 17 in the views shown in FIGS. 1 and 2, can be connected to first inlet 3 through conducting chamber 5. In FIG. 1, conducting chamber 5 is pressurized via first inlet 3, as indicated by dashed line region 19.

It can be seen from FIG. 1 that conducting chamber 5 of rotary spool 7 is connected to a first pressure chamber 23 by throughbores 21. The throughbores 21 extend through a cylinder 25 at the upper part of rotary spool 7, which cylinder is supported in a bore 27 in the base plate 15. It can be seen in FIG. 1 that there is a pressure present at an end face 31 of cylinder 25, i.e., that a pressure force is being exerted, which is indicated in FIG. 1 by means of two arrows 29. The pressure force indicated by the arrows 29 is transmitted via cylinder 25 to rotary spool 7, so that the latter can be pressed against intermediate plate 11 in a sealing contact arrangement.

It is apparent that the pressure force 29 results in a fluid-tight conducting chamber 5, provided that the forces acting on the end face 31 of the cylinder 25 are greater than the upwardly-directed forces acting on the conducting chamber, in an upward direction in the orientation shown in FIG. 1. To that end, the area relationships must be appropriately selected so that the end face 31 has a greater area than a horizontal inner surface of the conducting chamber 5.

It can be seen in FIG. 2 that a second pressure chamber 33 exists, which is bounded by an outer surface of rotary spool 7, an inner surface of housing 13 outwardly of bore 27, and the intermediate plate 11. Arrows 29 represent a pressure force that acts on an upper side of rotary spool 7, in a downward direction as shown in FIG. 2. The second pressure chamber 33 of valve 1′ can be pressurized by means of a second inlet 35, which is merely indicated schematically in FIGS. 1 and 2.

To rotate the rotary spool 7, cylinder 25 can be coupled through a shaft 39 to a drive 41, which is merely suggested.

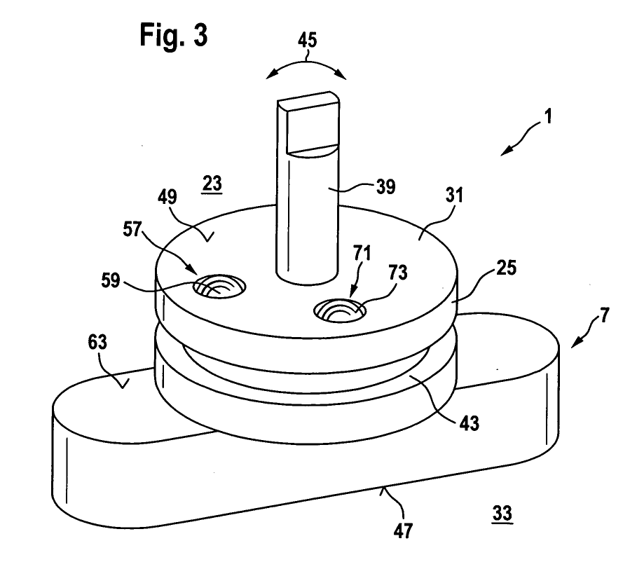

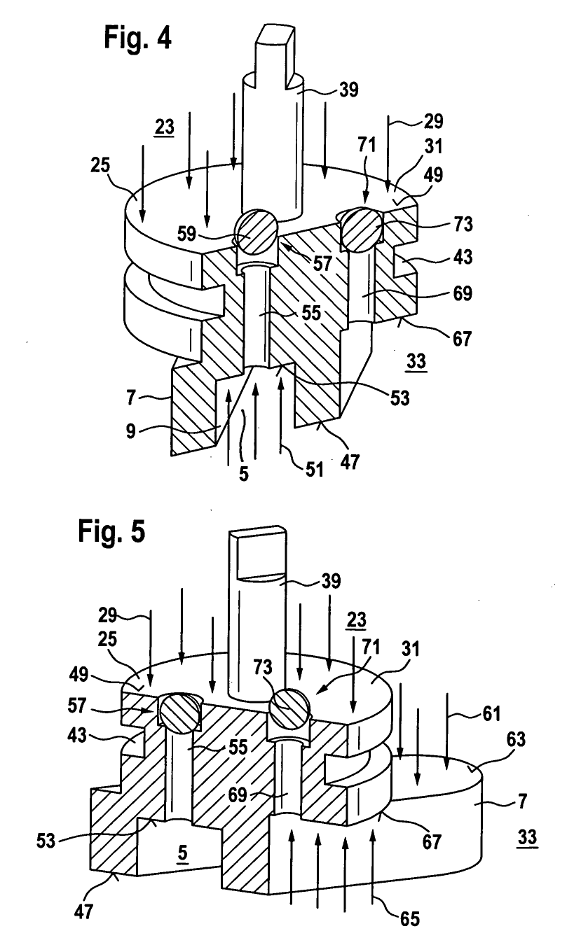

FIG. 3 is a perspective view from above of a rotary spool 7 of a valve 1 in accordance with an embodiment of the present invention. FIG. 4 shows the rotary spool 7 of FIG. 3 in a perspective view, partially in cross section. FIG. 5 shows another partial cross-sectional perspective view of the rotary spool 7 shown in FIGS. 3 and 4. The description below will only identify the differences from the known arrangement that is shown in FIGS. 1 and 2. Otherwise the description for FIGS. 1 and 2 is applicable.

Cylinder 25, which is coupled with shaft 39 and rotary spool 7, has a peripheral groove 43. A sealing ring (not shown) can be placed in the groove 43. The sealing ring can provide a sealing contact arrangement between groove 43 of cylinder 25 and a cylindrical inner wall of bore 27 of base plate 15. Advantageously, it is therefore possible to place cylinder 25 within bore 27 as a clearance fit and to provide the seal by means of the sealing ring (not shown). A fluid-tight fit between the opposed surfaces of cylinder 25 and bore 27, as in the known arrangement, is not required. That makes it possible to slightly tilt the rotary spool 7, or the entire system including rotary spool 7, cylinder 25, and shaft 39, within the bore 27, which tilting is indicated in FIG. 3 by a curved, double-headed arrow 45.

In that way, rotary spool 7, or a sealing surface 47 of rotary spool 7, can be placed more precisely in contact with the intermediate plate 11 of valve 1, not shown in greater detail in FIGS. 3 through 5. Slight tolerances when fitting the base plate 15 together with the intermediate plate 11 and/or the bore 27 of the base plate 15 can thus be compensated for by the slight tilting of rotary spool 7 relative to the central axis of bore 27. Therefore, a better-sealing contact arrangement of the sealing surface 47 of rotary spool 7 on the intermediate plate 11 results.

In FIG. 4, arrows 29 indicate a pressure force acting on a first pressure surface 49 defined by the end face 31 of cylinder 25. That pressure force is directed downward, and causes rotary spool 7 to be pressed against intermediate plate 11. An opposing upward pressure force, which acts on a second pressure surface 53, within conducting chamber 5, is indicated by means of arrows 51. First pressure surface 49 faces in an opposite direction from that of second pressure surface 53 and sealing surface 47. When designing the valve 1, the area of first pressure surface 49 must be made larger than the area of second pressure surface 53.

In contrast to the known structure shown in FIGS. 1 and 2, conducting chamber 5 is coupled with first pressure chamber 23 through a first bore 55 and a first check valve 57 provided in first bore 55. To that end, the first bore 55 is executed as a stepped bore, where a step of the first bore 55 serves as the ball seat for a ball 59 of the first check valve 57. Thus, the first check valve 57 is designed so that the ball 59 rises and thereby releases the first bore 55 as soon as a higher pressure exists in conducting chamber 5 than in first pressure chamber 23.

It is apparent that because of the connection by means of the first bore 55 and the first check valve 57, the same pressure conditions result as in the known arrangement shown in FIG. 1.

FIG. 5 shows rotary spool 7 in the second pressure situation, analogous to the representation of the known arrangement shown in FIG. 2. Here second pressure chamber 33 is pressurized via the second outlet 35. Arrows 61 indicate that downward-directed pressure forces, as shown in FIG. 5, act on a top side or a third pressure surface 63 of rotary spool 7. The downward pressure forces indicated by arrows 61 are counteracted by upward pressure forces indicated by arrows 65, the latter of which act on an underside or a fourth pressure surface 67 of cylinder 25.

In principle it is desirable to design the area of third contact surface 63 larger than the area of fourth contact surface 67, so that a net downward force results, as viewed in the orientation of FIG. 5, so that rotary spool 7 can reliably be pressed against the intermediate plate 11. Advantageously however, in accordance with the representation in FIG. 5 the second pressure chamber 33 is connected with the first pressure chamber 23 through a second bore 69 and a second check valve 71. Second bore 69 is formed similar to first bore 55, so that the pertinent description of bore 55 applies. Second check valve 71 likewise includes a ball 73, and opens as soon as the pressure is higher in the second pressure chamber 33 than in the first pressure chamber 23.

Under the pressure conditions as represented in FIG. 5, advantageously second check valve 71 is open and first check valve 57 is closed. First check valve 57 thus prevents an unwanted inflow of fluid from second inlet 35 into conducting chamber 5. It is apparent that by switching check valves 57 and 71, the first pressure surface 49 can be additionally pressurized with the pressure supplied through second inlet 35, so that an additional downwardly-directed force results to press rotary spool 7 against the intermediate plate 11, as represented by the arrows 29 in FIG. 5.

The two pressure conditions analogous to FIGS. 4 and 5 can be adjusted by a direction-switching valve (not shown) that is connected ahead of rotary spool 7. If the pressure is switched to the interior of rotary spool 7, i.e., into the conducting chamber 5—pressure conditions as represented in FIG. 4—that simultaneously causes the second pressure chamber 33 to be switched to zero pressure. Because of first bore 55 and second bore 69, the pressure is present at the first pressure surface 49 and the second pressure surface 53. Those surfaces are so designed that the resulting force acts in the direction of intermediate plate 11. To that end, the area of first pressure surface 49 must be designed to be larger than the area of second pressure surface 53.

Therefore rotary spool 7 itself provides for its own sealing, i.e., for the sealing surface 47 to be pressed against intermediate plate 11. Under the pressure conditions illustrated in FIG. 5, the pressure is present on third pressure surface 63 and on fourth pressure surface 67. In that case, the conducting chamber 5 is switched to zero pressure by the switching direction valve (not shown). Advantageously, through the interconnection by means of check valves 57 and 71 the pressure acting on the first pressure surface 49 can also be present, whereby the force pressing rotary spool 7 against intermediate plate 11 is increased. In particular, as a result it is also possible to enlarge the diameter of cylinder 25 without causing lifting of rotary spool 7 because of the similarly enlarged fourth pressure surface 67.

Advantageously, the check valves 57 and 71 constitute an OR element, where the first pressure surface 49 is pressurizable under both pressure conditions. That can improve the contact pressure of the rotary spool 7 against the intermediate plate 11. In addition, the clearance fit of cylinder 25 in bore 27 can result in rotary spool 7 being enabled to tilt slightly in the guideway, in order to thus be able to compensate for a possible angularity error.

Advantageously, the diameter of the cylinder 25 provided with the circumferential groove 43 can additionally be enlarged, whereby the first pressure surface 49 and therefore the resulting downward-acting pressure forces are also increased. Bores 55 and 69 are countersunk bores, which can receive the balls 59 and 73 to achieve the respective check valve functions. A sliding seal, not shown in FIGS. 3 through 5, can be inserted into the circumferential groove 43.

The end face 31 of cylinder 25 defines the first pressure surface 49. As soon as pressure is applied to the conducting chamber 5 within rotary spool 7, ball 59 of first check valve 57 rises and releases the oil pressure that is present at first pressure surface 49. Ball 73 of second check valve 71, on the other hand, is pressed into the ball seat by the existing pressure or by the pressure-free second pressure chamber 33, and thereby closes second bore 69. Advantageously, compared to the known arrangement shown in FIGS. 1 and 2, that results in a greater axial force, acting downward in the representations in FIGS. 3 through 5, to press rotary spool 7 against intermediate plate 11. That increased axial force can be further increased by enlarging the diameter of cylinder 25.

Under the pressure conditions represented in FIG. 5, in the known arrangement as illustrated in FIG. 2 heretofore only the third pressure surface 63 provided for the corresponding downward-acting pressure force. That pressure force is counteracted by the pressure forces acting on the fourth pressure surface 67. Advantageously, because of the switching of check valves 57 and 71, despite the enlarged diameter of cylinder 25, a greater downward-acting pressure force can be achieved by the additional pressure force acting on the first pressure surface 49.

The valve function of check valves 57 and 71 represents an OR element, because one of the two bores 55 and 69 is always open when there is pressure present. Because of that OR element, the first pressure surface 49 of end face 31 of cylinder 25 can be used by both pressures as an effective area for pressing rotary spool 7 against the intermediate plate 11. The higher pressure force guarantees better contact pressure, and thus lower leakage in both pressure positions. An additional measure, which provides for better sealing when there is a slight angular displacement of bore 27 that is designed to receive rotary spool 7, cylinder 25, and shaft 39, is to use the sliding seal ring (not shown) in the circumferential groove 43.

In comparison to the known arrangement shown in FIGS. 1 and 2, cylinder 25 in accordance with the present invention, in contrast, is not configured to provide a close fit, but is smaller in diameter than the bore 27 by about 0.2 mm, for example. As a result, the rotary spool 7 has the possibility of minimal tilting in the bore 27. That enables rotary spool 7 to compensate for any tilting of the bore 27 that can occur, and thus to always lie flat against the intermediate plate 11. Since the periphery of cylinder 25 serves to separate first pressure chamber 23 and second pressure chamber 33, i.e., it must assume a sealing function, the sliding seal ring (not shown) can be inserted into the groove 43. The sliding seal ring advantageously guarantees sealing at the periphery of the cylinder 25 against the bore 27 in both pressure directions.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A valve comprising:
a housing;
a rotary spool rotatably received in the housing and including a conducting chamber surrounded by a sealing surface;
a first inlet communicating with the conducting chamber;
a plurality of outlets each of which is connectable to the conducting chamber individually as a function of a rotational position of the rotary spool;
wherein the conducting chamber is connectable to a first pressure chamber through a first check valve.

2. A valve in accordance with claim 1, including a cylinder carried by the rotary spool, wherein the cylinder is rotatably received in a bore of the valve housing with a clearance fit.

3. A valve in accordance with claim 2, wherein the cylinder includes an upper end face that forms a first pressure surface, wherein the first pressure surface and the bore define the first pressure chamber.

4. A valve in accordance with claim 1, including a second pressure chamber that surrounds the rotary spool and that is connected with the first pressure chamber through a second check valve at the first pressure surface.

5. A valve in accordance with claim 4, including a second inlet that is connectable with the second pressure chamber.

6. A valve in accordance with claim 5, wherein the first check valve is open and the second check valve is closed when the first inlet is pressurized and the second inlet is unpressurized, and vice versa.

7. A valve in accordance with claim 2, wherein the cylinder includes a peripheral groove to receive a sliding-seal ring to provide a seal between the valve housing bore and the cylinder.

8. A valve in accordance with claim 3, wherein the valve includes an intermediate plate in contact with the housing and the rotary spool includes a sealing surface situated at an end opposite to the first pressure surface, and wherein pressure forces that act on the first pressure surface serve to urge the rotary spool against the intermediate plate to provide sealing contact therebetween.

9. A valve in accordance with claim 8, wherein the intermediate plate bounds the conducting chamber of the rotary spool and includes the first inlet and the at least one outlet.

10. A valve in accordance with claim 8, wherein the intermediate plate includes the at least one second inlet.

11. A valve in accordance with claim 8, wherein the intermediate plate bounds the second pressure chamber.

12. A hydraulic system of a hydraulic shift transmission including a valve in accordance with claim 1.
